(19) United States
(12) Patent Application Publication
(10) Pub. No.: US 2015/0332418 A1
(43) Pub. Date: Nov. 19, 2015

(54) REAL ESTATE MANAGEMENT SYSTEM AND METHOD

(71) Applicants: Brent Jonathan Wilson, Edgerton, OH (US); Bartley Eugene Westfall, West Unity, OH (US)

(72) Inventors: Brent Jonathan Wilson, Edgerton, OH (US); Bartley Eugene Westfall, West Unity, OH (US)

(73) Assignee: TOTAL REAL ESTATE RESOURCE, LLC, Bryan, OH (US)

(21) Appl. No.: 14/716,460

(22) Filed: May 19, 2015

Related U.S. Application Data
(60) Provisional application No. 62/000,281, filed on May 19, 2014.

(51) Int. Cl. G06Q 50/16; G06Q 10/00

(52) U.S. Cl. CPC G06Q 50/16; G06Q 10/00

(57) ABSTRACT

A real estate management system including a computing device configured to at least one of collect, transmit, receive, and display nationwide real estate property and auction listing data, the computing device having a user interface accessible to at least one of a real estate broker, a real estate agent, a real estate appraiser, a potential buyer, and a potential seller; and a management server in communication with the computing device, wherein the management server is configured to centralize nationwide real estate property and auction listing data into a single listing resource.

### CROSS REFERENCE TO RELATED APPLICATIONS

This application is entitled to claim the benefit of, and claims priority to, U.S. provisional patent application Ser. No. 62/000,281 filed May 19, 2014, the entire disclosure of which is incorporated herein by reference.

### FIELD OF THE INVENTION

The present invention relates generally to a real estate system and, more particularly, to a real estate management system and method.

### BACKGROUND OF THE INVENTION

For decades, the most effective way to expose a property to thousands of potential buyers has been to hire a real estate agent or broker. Typically, the agent or broker will list the property on a multiple listing service (MLS). The MLS is a collection of private databases used by agents and brokers who agree to share their listing agreements with one another to locate ready, willing and able buyers for properties more quickly than they could on their own. The agents and brokers earn sales commissions from the sale of properties they listed and properties they help sell as a buyer's representative.

Today, agents and brokers, through more than 900 MLSs, share information on properties they have listed and invite other brokers to cooperate in their sale. The MLSs benefit sellers by increased exposure of their property to thousands of potential buyers they would otherwise never reach. Whereas, the potential buyers receive the benefit of instant access to listings that match specified criteria, beyond price range and location, while working with only one agent or broker. The buyers and sellers can work with the professional of their choice, confident that they have access to the largest pool of properties for sale in the marketplace. The agent or broker must have the written consent of the seller to include the property on a MLS.

Most MLSs require that the agent or broker release new listings to the service within a short time frame of obtaining the listing. Usually, the agents and brokers who use the MLS in the United States are members of the National Association of Realtors (NAR), a real estate trade association. NAR encourages innovation and competition in real estate brokerage, including different business models. At one time it was required to be a member of the NAR to be a member of a MLS; however, membership in the NAR is no longer required. The cost to join a local MLS depends completely on the local association. Every association has their own fee schedule. Typically, the membership fees for each association can vary from about $250 to well over $1000 a year. Most associations also require a first time initiation fee plus the regular dues. Most brokers and agents are members of at least one MLS, if not several, thereby costing the brokers and agents hundreds, if not, thousands of dollars per year in MLS membership fees.

Accordingly, it would be desirable to develop a real estate management system and method which centralizes nationwide real estate listing data into a single MLS to simplify and improve real estate transactions, while minimizing a complexity and cost to the real estate professionals.

### SUMMARY OF THE INVENTION

In concordance and agreement with the present disclosure, a real estate management system and method which centralizes nationwide real estate listings into a single MLS to simplify and improve real estate transactions, while minimizing a complexity and cost to the real estate professionals, has surprisingly been discovered.

In one embodiment, a real estate management system, comprises: a computing device configured to at least one of collect, transmit, receive, and display nationwide real estate property and auction listing data, the computing device having a user interface accessible to at least one user; and a management server in communication with the computing device, wherein the management server is configured to at least one of receive, analyze, and centralize the nationwide real estate property and auction listing data.

In another embodiment, a real estate management method, comprises the steps of: providing a computing device configured to at least one of collect, transmit, receive, and display nationwide real estate property and auction listing data, the computing device having a user interface accessible to at least one user; providing a management server in communication with the computing device, wherein the management server is configured to at least one of receive, analyze, and centralize the nationwide real estate property and auction listing data; and centralizing the nationwide real estate property and auction listing data.

In yet another embodiment, a real estate management method, comprises the steps of: providing a computing device configured to at least one of collect, transmit, receive, and display nationwide real estate property and auction listing data, the computing device having a user interface accessible to at least one user; providing a management server in communication with the computing device, wherein the management server is configured to at least one of receive, analyze, and centralize the nationwide real estate property and auction listing data; centralizing the nationwide real estate property and auction listing data; providing a business-to-user section in communication with at least one of the computing device and the management server, wherein the business-to-user section is configured to provide general public access to the centralized nationwide real estate property and auction listing data; and providing a member portal in communication with at least one of the computing device and the management server, wherein the member portal is configured to provide real estate professionals access to the centralized nationwide real estate property and auction listing data.

### BRIEF DESCRIPTION OF THE DRAWINGS

The above, as well as other objects and advantages of the invention, will become readily apparent to those skilled in the art from a reading of the following detailed description of the invention when considered in the light of the accompanying drawings in which:

FIG. 1 is a flow diagram of a real estate management system and method according to an embodiment of the present invention;

FIG. 2 is a flow diagram of a registration process of the real estate management system and method illustrated in FIG. 1 according to an embodiment of the present invention;

FIG. 3 is a flow diagram of a new property and auction listing process of the real estate management system and method illustrated in FIG. 1 according to an embodiment of the present invention;

FIG. 4 is a flow diagram of a listing status process of the real estate management system and method illustrated in FIG. 1 according to an embodiment of the present invention;

FIG. 5 is a flow diagram of a reporting process of the real estate management system and method illustrated in FIG. 1 according to an embodiment of the present invention; and

FIG. 6 is a flow diagram of a comparative market analysis (CMA) process of the real estate management system and method illustrated in FIG. 1 according to an embodiment of the present invention.

### DETAILED DESCRIPTION OF THE INVENTION

The following detailed description and appended drawing describe and illustrate various exemplary embodiments of the invention. The description and drawing serve to enable one skilled in the art to make and use the invention, and are not intended to limit the scope of the invention in any manner.

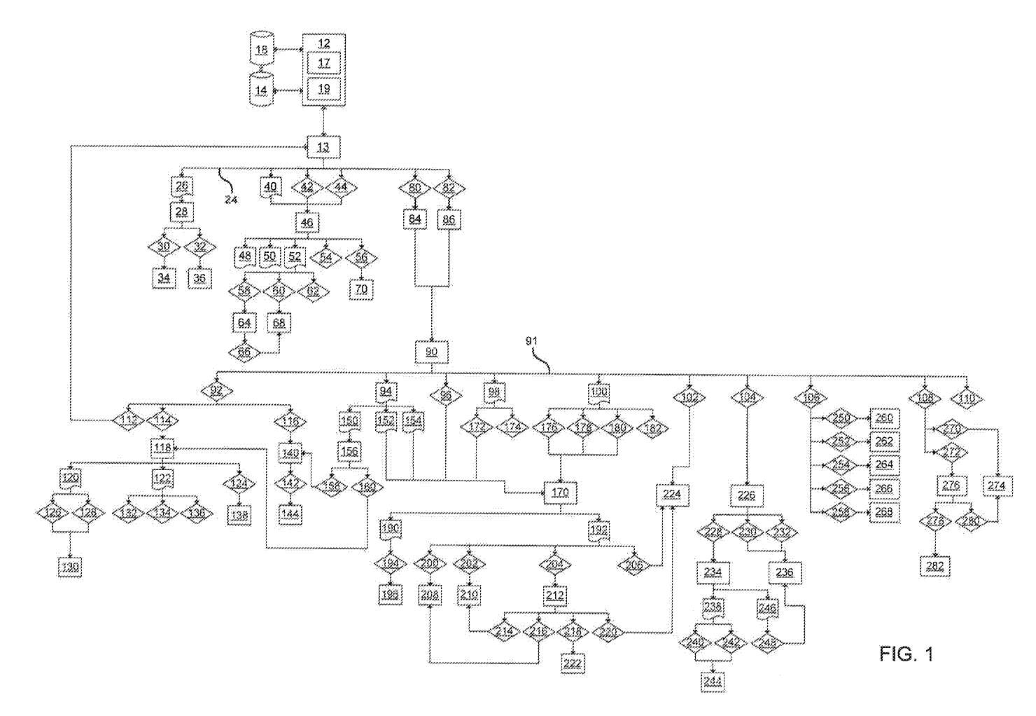

FIG. 1 depicts a real estate management system and method 10 according to an embodiment of the present invention. The real estate management system and method 10 is configured to centralize nationwide real estate property and auction listing data into a single listing resource accessible by real estate professionals and consumers across the United States. As shown, the system 10 includes a computing device (CD) 12 having a user interface 13 (i.e. internet website, internet portal, mobile application, etc.), and a management server 14 configured to centralize nationwide real estate property and auction listing data into a single listing resource. It is understood that additional computing devices 12 having user interfaces 13 and additional management servers 14 may be employed as desired. Various graphical representations of the user interface 13 can be developed and employed as desired. The user interface 13 may be associated with a bar code or QR code so that the user interface 13 can be quickly accessed via the CD 12, or in the alternative, the bar code or QR code can be used to login to the user interface 13. The system 10 may also include a payment information server 18 as a separate component or integrated into the CD 12 or the management server 14, if desired. It is understood that the system 10 may include other additional components necessary for operation of the system 10.

In certain embodiments, the CD 12 can be any device suitable to collect, transmit, receive, and display data including, but not limited to those which are categorized by the generic, technological terms of smartphone, portable consumer electronic device, personal computing tablet, personal lap-top or desktop computer, and personal notebook computer. Examples of such CD 12 include, but are not limited to the Apple iPhone, Apple iPad, Blackberry Playbook, Blackberry Tablet, Samsung Galaxy Tab, Microsoft Surface Pro, Motorola Droid, HTC Android, and numerous others sold by Apple, HTC, Motorola, Dell, Samsung, HP, Sanyo, Blackberry, Toshiba, Acer, Lenovo, Asus, and the like.

The CD 12 includes a memory 17 and a processor 19. The memory 17 may be a single storage device or may be multiple storage devices. Portions of the memory 17 may also be located on the processor 19. Furthermore, the memory 17 may be a solid state storage system, a magnetic storage system, an optical storage system, or any other suitable storage system. In certain embodiments, the memory 17 is configured to store a real estate management method or application. Other data may be stored in the memory 17 as described hereinafter. The real estate management method configures the processor 19 of the CD 12 to generate the user interface 13.

In certain embodiments, the real estate management system and method 10 also includes a business-to-user (B2U) section 24. The B2U section 24 provides a user (i.e. general public, a buyer, a seller, a lessee, a lessor) with access via a public home page to information related to a real estate professional (e.g. a broker, agent, and the like, etc.) and/or a real estate company. When a real estate professional or real estate company search is desired, a search process is initiated via a control element. It is understood that the control element can be any control element as desired such as a drop-down menu option, a radio button, a hyperlink, a command prompt window, and the like, or any combination thereof, for example. It is also understood that accessibility to the search process can be limited to a certain user such as a potential buyer, for example. The search process may include a search step in which the user inputs at least one search criteria or keyword (i.e. property type, state, city, zip, owner's name and contact information, and the like, etc.) into a search query module 26.

The search query module 26 is in communication with the management server 14 to search and analyze the real estate professional and real estate company information stored in the management server 14. The search query module 26 also transmits a result list 28 to the user interface 13. The user may select to view a desired real estate agent via a control element 30 or a desired real estate company via a control element 32. It is understood that each of the control elements 30, 32 can be any control element as desired such as a drop-down menu option, a radio button, a hyperlink, a command prompt window, and the like, or any combination thereof, for example. If the user selects the desired real estate agent or the desired real estate company, a respective real estate agent profile 34 or real estate company profile 36 is transmitted to the user interface 13 for viewing, printing, emailing, and other means of use by the user. It is understood that any information electronically transmitted may be electronically transmitted via a secured and encrypted email. In certain embodiments, the user is directly connected to the real estate professional or immediately provided with the contact information (i.e. telephone number, website, email, etc.) of the real estate professional unlike the prior art MLSs.

Once use of the search process is no longer desired, the user terminates the search process by simply closing the user interface 13 or the search query module 26. However, it is understood that a logout control element (not shown) may be employed. It is understood that the control element can be any control element as desired such as a drop-down menu option, a radio button, a hyperlink, a command prompt window, and the like, or any combination thereof, for example.

In certain embodiments, the B2U section 24 also provides the user with access to property and/or auction listings inputted by at least one real estate professional. However, the user may not be permitted to receive or view all of the information relating to the property and auction listing. For example, the user may not be able to receive or view information pertaining to commission or referral fees and private remarks of the real estate professionals.

When a search of the property and/or auction listings is desired, a search process is initiated via a quick listing search query module 40, an advanced search control element 42, or a browse map control element 44. It is understood that the control elements 42, 44 can be any control element as desired such as a drop-down menu option, a radio button, a hyperlink, a command prompt window, and the like, or any combination thereof, for example. It is also understood that accessibility to the search of the property and/or auction listings can be limited to a certain user such as a potential buyer, for example. At least one of the quick listing search query module 40, the advanced search control element 42, and the browse map control element 44 may permit the user to input at least one search criteria or keyword (i.e. property type, state, city, zip, minimum price, maximum price, unit type, owner's name and contact information, mortgage information, availability time slots for showing, owner closing, scheduling and access restrictions, school district, address information, actual built-up area, age, renovation description, sewer district, furnishing description, corner unit indicator, number of bedrooms and floor location, number of bathrooms and floor location, amenities, number of stories, free form description of property, total land area, shape of land area, dimensions of rooms, income from property rental or use, high/low rise, apartment/condo facilities description, scenic views, and the like, etc.) to limit the search results. It is understood that the browse map control element 44 may include map searching capabilities and/or global positioning system (GPS) mapping compatibility if desired.

Each of the quick listing search query module 40, the advanced search control element 42, and the browse map control element 44 is in communication with the management server 14 to search and analyze property and auction listing references and data stored in the management server 14. Selection of at least one of the quick listing search query module 40, the advanced search control element 42, and the browse map control element 44 transmits an interactive map 46 to the user interface 13. Based upon the interactive map 46, the user may select an advance search option module 48, a map module 50, a listing module 52, a save search control element 54, and/or a print listing map control element 56. It is understood that the control elements 54, 56 can be any control element as desired such as a drop-down menu option, a radio button, a hyperlink, a command prompt window, and the like, or any combination thereof, for example. In certain embodiments, the user may select to view a desired listing via a control element 58, print listings via a control element 60, or view, print, and/or save favorite listings via a control element 62. It is understood that the control elements 58, 60, 62 can be any control element as desired such as a drop-down menu option, a radio button, a hyperlink, a command prompt window, and the like, or any combination thereof, for example.

If the user selects to view the desired property or auction listing, a full listing 64 is transmitted to the user interface 13 for viewing, printing via a control element 66, emailing, and other means of use by the user. It is understood that any information electronically transmitted may be electronically transmitted via a secured and encrypted email. In certain embodiments, if the user selects one of the property or auction listings, the user is directly connected to the real estate professional or immediately provided with the contact information (i.e. telephone number, website, email, etc.) of the real estate professional unlike the prior art MLSs. It is understood that the B2U section 24 can be configured to transmit at least one of open house notifications and information and automatic appointment setting links and alerts to the user. It is further understood that the B2U section 24 can be configured to transmit national emergency, weather, amber and silver alerts to the user. The alerts can be limited to those related to the search criteria and keywords inputted by the user if desired. If the user selects to print listings, a listing results 68 are transmitted to the user interface 13 for viewing, printing via the control element 66, emailing, and other means of use by the user.

If the user selects the print listing map control element 56, a map 70 is transmitted to the user interface 13 for viewing, printing, emailing, and other means of use by the user. It is understood that any information electronically transmitted may be electronically transmitted via a secured and encrypted email.

Once use of the search process is no longer desired, the user terminates the search process by simply closing the user interface 13 or the modules 40, 48, 50, 52. However, it is understood that a logout control element (not shown) may be employed. It is understood that the control element can be any control element as desired such as a drop-down menu option, a radio button, a hyperlink, a command prompt window, and the like, or any combination thereof, for example.

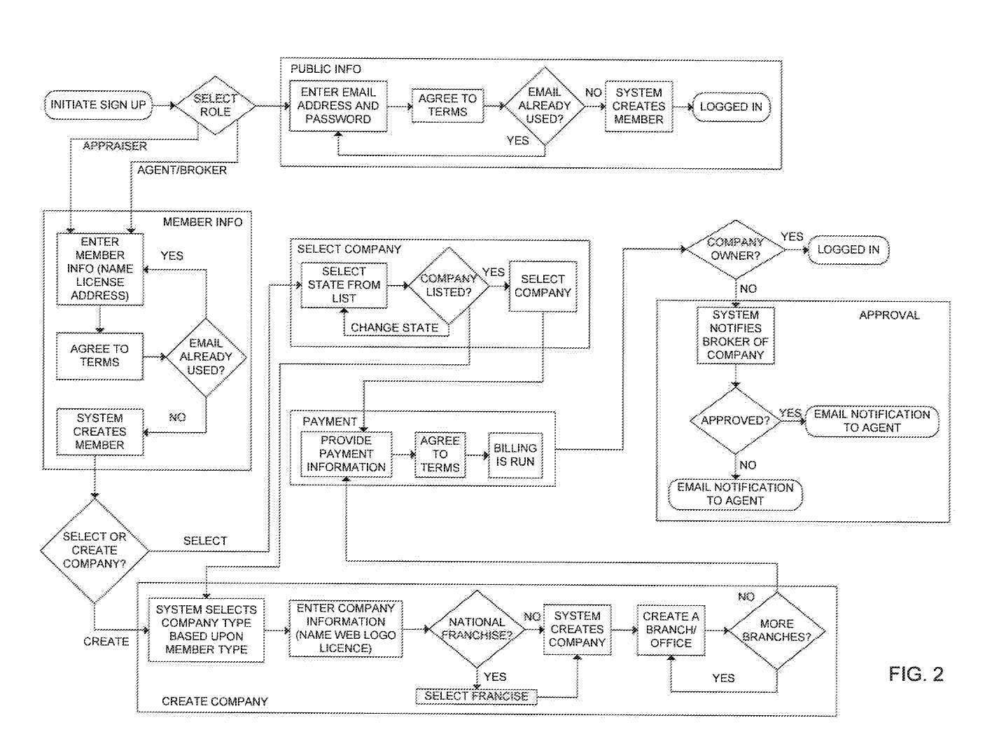

In certain embodiments, the real estate management method includes a login process and a registration (sign up) process (shown in FIG. 2) to provide access to a member portal. Each of the login process and the registration process is in communication with the management server 14 to search and analyze member data stored in the management server 14 and save member data to the management server 14. When the login process is desired, the login process is initiated via a login control element 80, and when the registration process is desired, the registration process is initiated via a registration control element 82. It is understood that the control elements 80, 82 can be any control element as desired such as a drop-down menu option, a radio button, a hyperlink, a command prompt window, and the like, or any combination thereof, for example. It is also understood that accessibility to the member portal via at least one of the login process and the registration process can be limited to the real estate professional. If the user selects the login process, a login page 84 is transmitted to the user interface 13. The login page 84 permits the user to input at least one of a user name (i.e. email address) and password (i.e. answer to secure question). If the user inputs the required username and password, a member home page 90 of the member portal is transmitted to the user interface 13. If the user selects the registration process, a registration page 86 is transmitted to the user interface 13. The registration page 86 permits the user to initiate registration, and more particularly the registration process.

As shown in FIG. 2, the registration process includes an identification step in which the user identifies or selects a role as an appraiser, an agent/broker, or a member of the public. It is understood that the identification step can permit the user to identify as other types of professionals such as an auctioneer, for example, if desired. It is further understood that no real estate association or affiliation membership is required to be a registered user of the real estate management system and method 10.

In certain embodiments, when the user is the member of the public, the registration process via a public information module requests the user to enter contact information such as an email address and password, for example, and agree to terms of use of the real estate management system and method 10. The public information module is in communication with the management server 14 to search and analyze member data stored in the management server 14 and save member data to the management server 14. If the email address has not been used by another user, the registration process creates a member profile and the user is logged into the member portal. Alternatively, if the email address is not available, the registration process requests the user to enter another email address and agree to the terms of use of the real estate management system and method 10. The steps of entering an email address and password, and agreeing to the terms of use of the real estate management system and method 10 are repeated until the user enters an available email address, the member profile is created, and the user is logged into the member portal.

When the user is the appraiser or the agent/broker, the registration process requests the user to enter member information (e.g. name, real estate license number, address, telephone number, email address, password, and the like) into a member information module, and agree to the terms of use of the real estate management system and method 10. It is understood that the member information inputted into the member information module can be any contact information needed for operation of the real estate management system and method 10. The member information module is in communication with the management server 14 to search and analyze member data stored in the management server 14 and save member data to the management server 14.

If the email address has not been used by another user, the registration process creates an appraiser or agent/broker profile. Alternatively, if the email address is not available, the registration process requests the user to enter another email address and agree to the terms of use of the real estate management system and method 10. The steps of entering an email address and agreeing to the terms of use of the real estate management system and method 10 are repeated until the user enters an available email address and the appraiser or agent/broker profile is created.

In certain embodiments, the registration process may also include an agent/broker verification step in which the agent/broker inputs the real estate license number into an agent/other verification module (not shown). The agent/other verification module is in communication with the at least one state or federal real estate licensing database to validate the real estate license number inputted by the agent/broker.

Once the appraiser or agent/broker profile is created, the registration process requests the user to create or select a desired company. When the user decides to create the desired company, the registration process initiates a company creation module. In the company creation module, the registration process selects a company type based upon whether the user is an appraiser or an agent/broker. The company creation module is in communication with the management server 14 to search and analyze company data stored in the management server 14 and save company data to the management server 14. The registration process then requests the user to enter company information such as name, address, telephone number, real estate license number, logo, email address, password, and the like, for example. The registration process then requests the user to select whether the company is a national real estate franchise. If the company is not a national real estate franchise, the registration process creates a company profile. Alternatively, if the company is a national real estate franchise, the registration process requests the user to select an associated real estate franchise. When the associated real estate franchise is selected, the registration process creates the company profile.

Once the company profile is created, the registration process creates a branch/office and requests the user to enter additional branches/offices. If the user indicates that additional branches/offices are desired, the registration process sets the first branch/office as a default main branch/office and creates the additional branches/offices. Alternatively, if the user indicated that additional branches/offices are not desired, the registration process initiates a payment module for receiving a user registration fee for the real estate management system and method 10.

When the user decides to select the desired company, the registration process initiates a company selection module. The company selection module is in communication with the management server 14 to search and analyze company data stored in the management server 14 and save company data to the management server 14. The registration process requests the user to select a desired state from a state listing. If the desired company is listed, the registration process requests the user to select the desired company. Alternatively, if the desired company is not listed, the registration process requests the user to select another state from the state listing. The steps of selecting another state from the state listing are repeated until the desired company is listed and is selected by the user. When the desired company is selected, the registration process initiates the payment module for receiving the user registration fee. As another alternative, if the desired company is not listed, the registration process initiates the company creation module for creating another company profile.

In certain embodiments, the registration process requests the user to input payment information (i.e. a credit or debit card number, a bank account number, a billing address, or the like, etc.) into the payment module for receiving the user registration fee. The payment module may be in communication with at least one of the management server 14 or the payment information server 18 configured to store and retrieve the payment information of each of the users. It is understood that the payment information server 18 can be an internally or externally hosted server if desired. It is further understood that the agent/broker may be responsible for paying their own user registration fee for the real estate management system and method 10. However, the user registration fee may be discounted for the agent/broker that is an existing member of the National Association of Realtors. It is also contemplated that the agent/broker only has to pay one annual registration fee instead of a membership fee for multiple MLSs. The registration process then requests the user to agree to terms of use of the real estate management system and method 10. Thereafter, the registration process initiates payment. If the selected company is owned by the user, the registration process logs the user into the member portal.

Alternatively, if the selected company is not owned by the user, the registration process initiates an approval module. The approval module is in communication with the management server 14 to search and analyze company data stored in the management server 14 and save company data to the management server 14. The approval modules notifies the broker of the selected company to obtain approval for registration with the real estate management system and method 10. When the broker provides approval or disapproval for registration, the registration process transmits the approval or disapproval to the user (i.e. agent). It is contemplated that the terms of use of the real estate management system and method 10 include that payment is completed immediately, yet access to the member portal by the user is not permitted until the broker provides approval.

As illustrated in FIG. 1, the real estate management method further includes a member section 91 of the member portal. The member section 92 provides the user access to various information and data to assist real estate professionals. In certain embodiments, the real estate management method includes a member control element 92, a search query module 94, a browse map control element 96, a hotsheet module 98 configured to report via a hotsheet new or recent activity in the MLS (e.g. new listings, status changes, and price changes since the last hotsheet was viewed), an inventory watch module 100, a new listing control element 102, a client control element 104, a reports control element 106, a comparative market analysis (CMA) control element 108, and a resources control element 110. It is understood that the control elements 92, 96, 102, 104, 106, 108, 110 can be any control element as desired such as a drop-down menu option, a radio button, a hyperlink, a command prompt window, and the like, or any combination thereof, for example.

In certain embodiments, the member control element 92 initiates a member process of the real estate management method. Once use of the member process is no longer desired, the user terminates the member process via a control element 112. It is understood that the control element 112 can be any control element as desired such as a drop-down menu option, a radio button, a hyperlink, a command prompt window, and the like, or any combination thereof, for example. It is understood that upon termination of the member process, the real estate management method may direct the user to the public home page of the B2U process 24. Alternatively, the member process requests the user to select and/or view a company profile via a control element 114 or an agent/broker profile via a control element 116. It is understood that the control elements 114, 116 can be any control element as desired such as a drop-down menu option, a radio button, a hyperlink, a command prompt window, and the like, or any combination thereof, for example.

If the user selects the company profile, the company profile 118 of the user is transmitted to the user interface 13 for viewing, printing, emailing, and other means of use by the user. It is understood that any information electronically transmitted may be electronically transmitted via a secured and encrypted email. Based upon the company profile 118, the user may select an office list module 120, an agent list module 122, and an edit company control element 124. It is understood that the control element 124 can be any control element as desired such as a drop-down menu option, a radio button, a hyperlink, a command prompt window, and the like, or any combination thereof, for example. In certain embodiments, the user may select to create an office listing via a control element 126 or edit an office listing via a control element 128. It is understood that the control elements 126, 128 can be any control element as desired such as a drop-down menu option, a radio button, a hyperlink, a command prompt window, and the like, or any combination thereof, for example. If the user selects to create or edit an office listing, an office listing editor 130 is transmitted to the user interface 13 to permit the user to input and/or modify information pertaining to the office listing of the company profile. It is understood that any information electronically transmitted may be electronically transmitted via a secured and encrypted email.

In certain embodiments, the user may select to approve an agent listing via a control element 132, edit an agent listing via a control element 134, or delete an agent listing via a control element 136. It is understood that the control elements 132, 134, 136 can be any control element as desired such as a drop-down menu option, a radio button, a hyperlink, a command prompt window, and the like, or any combination thereof, for example. If the user selects to edit an agent listing, the user is permitted to edit the agent listing of the company profile as desired such as modify an associated office of the agent listing, for example.

In certain embodiments, the user may select to edit the company profile via the edit company control element 124. If the user selects to edit company information of the company profile, a company profile editor 138 is transmitted to the user interface 13 to permit the user to input and/or modify information pertaining to the company profile. It is understood that any information electronically transmitted may be electronically transmitted via a secured and encrypted email.

If the user selects the appraiser or agent/broker profile, the appraiser or agent/broker profile 140 of the user is transmitted to the user interface 13 for viewing, printing, emailing, and other means of use by the user. It is understood that any information electronically transmitted may be electronically transmitted via a secured and encrypted email. In certain embodiments, the user may select to edit the appraiser or agent/broker profile via an edit control element 142. It is understood that the edit control element 142 can be any control element as desired such as a drop-down menu option, a radio button, a hyperlink, a command prompt window, and the like, or any combination thereof, for example. If the user selects to edit appraiser or agent/broker information of the appraiser or agent/broker profile, an appraiser or agent/broker profile editor 144 is transmitted to the user interface 13 to permit the user to input and/or modify information pertaining to the appraiser or agent/broker profile. It is understood that any information electronically transmitted may be electronically transmitted via a secured and encrypted email.

When a real estate professional or real estate company search is desired, a search process is initiated via the search query module 94. The search process may include a search step in which the user inputs at least one search criteria or keyword (i.e. property type, state, city, zip, owner's name and contact information, and the like, etc.) into an agent/broker or company search query module 150.

The agent/broker or company search query module 150 is in communication with the management server 14 to search and analyze the real estate professional and real estate company information stored in the management server 14. The agent/broker or company search query module 150 transmits a result list 156 to the user interface 13. The user may select to view a desired real estate agent via a control element 158 or a desired real estate company via a control element 160. It is understood that the control elements 158, 160 can be any control element as desired such as a drop-down menu option, a radio button, a hyperlink, a command prompt window, and the like, or any combination thereof, for example. If the user selects the desired real estate agent, the real estate agent profile 140 is transmitted to the user interface 13 for viewing, printing, emailing, and other means of use by the user. If the user selects the desired real estate company, the real estate company profile 118 is transmitted to the user interface 13 for viewing, printing, emailing, and other means of use by the user. It is understood that any information electronically transmitted may be electronically transmitted via a secured and encrypted email. In certain embodiments, the user is directly connected to the real estate professional or immediately provided with the contact information (i.e. telephone number, website, email, etc.) of the real estate professional unlike the prior art MLSs.

Once use of the search process is no longer desired, the user terminates the search process by simply closing the user interface 13 or the agent/broker or company search query module 150. However, it is understood that a logout control element (not shown) may be employed. It is understood that the control element can be any control element as desired such as a drop-down menu option, a radio button, a hyperlink, a command prompt window, and the like, or any combination thereof, for example.

When a search of the property and/or auction listings is desired, a listing search process is initiated via an advanced search query module 152, a quick listing search query module 154, or the browse map control element 96. The listing search process allows the real estate professional to search real estate property and auction listings for the entire United States. It is understood that the control element 96 can be any control element as desired such as a drop-down menu option, a radio button, a hyperlink, a command prompt window, and the like, or any combination thereof, for example. It is also understood that accessibility to the search of the property and/or auction listings can be limited to a certain user such as a potential buyer, for example. At least one of the advanced search query module 152, the quick listing search query module 154, and the browse map control element 96 may permit the user to input at least one search criteria or keyword (i.e. property type, state, city, zip, minimum price, maximum price, unit type, owner's name and contact information, mortgage information, availability time slots for showing, owner closing, scheduling and access restrictions, school district, address information, actual built-up area, age, renovation description, sewer district, furnishing description, corner unit indicator, number of bedrooms and floor location, number of bathrooms and floor location, amenities, number of stories, free form description of property, total land area, shape of land area, dimensions of rooms, income from property rental or use, high/low rise, apartment/condo facilities description, scenic views, and the like, etc.) to limit the search results. It is understood that the browse map control element 96 may include map searching capabilities and/or global positioning system (GPS) mapping compatibility if desired.

Each of the advanced search query module 152, the quick listing search query module 154, and the browse map control element 96 is in communication with the management server 14 to search and analyze property and auction listing references and data stored in the management server 14. Selection of at least one of the advanced search query module 152, the quick listing search query module 154, and the browse map control element 96 transmits an interactive map 170 to the user interface 13.

Additionally, the interactive map 170 may be transmitted to the user interface 13 when the user selects at least one of a view listings control element 172 or a settings 174 of the hotsheet module 98 or an agent/broker listings controls element 176, a company listings control element 178, or an office listings control element 180 of the inventory watch module 100. It is understood that the control elements 172, 174, 176, 178, 180 can be any control element as desired such as a drop-down menu option, a radio button, a hyperlink, a command prompt window, and the like, or any combination thereof, for example. Each of the hotsheet module 98 and the inventory watch module 100 is in communication with the management server 14 to search and analyze property and auction listing references and data stored in the management server 14.

As illustrated, the inventory watch module 100 may also permit the user to filter the property and/or auction listings via a filter options control element 182, if desired. It is understood that the control element 182 can be any control element as desired such as a drop-down menu option, a radio button, a hyperlink, a command prompt window, and the like, or any combination thereof, for example.

Based upon the interactive map 170, the user may select a map module 190 or a listing module 192. Each of the map module 190 and the listing module 192 is in communication with the management server 14 to search and analyze property and auction listing references and data stored in the management server 14. As shown, the map module 190 includes a print listing map control element 194. It is understood that the print listing map control element 194 can be any control element as desired such as a drop-down menu option, a radio button, a hyperlink, a command prompt window, and the like, or any combination thereof, for example. If the user selects the print listing map control element 194, a map 196 is transmitted to the user interface 13 for viewing, printing, emailing, and other means of use by the user. It is understood that any information electronically transmitted may be electronically transmitted via a secured and encrypted email.

In certain embodiments, the user may select in the listing module 192 to print public listings via a control element 200, print agent/broker listings via a control element 202, view a desired listing via a control element 204, and edit listings via a control element 206. It is understood that the control elements 200, 202, 204, 206 can be any control elements as desired such as a drop-down menu option, a radio button, a hyperlink, a command prompt window, and the like, or any combination thereof, for example. If the user selects to print public or agent/broker listings, the respective public listings 208 or agent/broker listings 210 are transmitted to the user interface 13 for viewing, printing, emailing, and other means of use by the user. It is understood that any information electronically transmitted may be electronically transmitted via a secured and encrypted email.

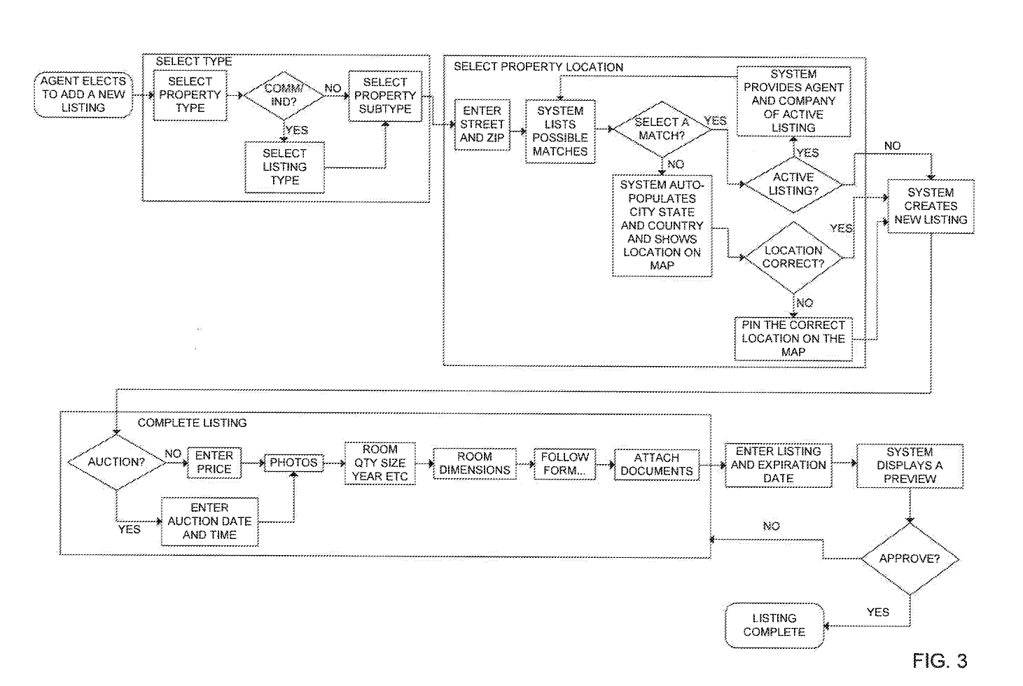

If the user selects to view a desired property or auction listing, a full listing 212 is transmitted to the user interface 13 for viewing, printing via a control element 214 for a full agent listing, printing via a control element 216 for a full public listing, emailing, and other means of use by the user. It is understood that any information electronically transmitted may be electronically transmitted via a secured and encrypted email. In certain embodiments, when user selects the desired property or auction listing, the user can select to view a property history report 222 of the desired property or auction listing via a control element 218. If the user selects to view the property history report 222, the property history report 222 is transmitted to the user interface 13 for viewing, printing, emailing, and other means of use by the user. In certain embodiments, the user can select to edit the desired property or auction listing via a control element 220. As illustrated, the edit control elements 206, 220 initiate a new property and auction listing process 224 (shown in FIG. 3) of the real estate management method. It is understood that the control elements 206, 220 can be any control element as desired such as a drop-down menu option, a radio button, a hyperlink, a command prompt window, and the like, or any combination thereof, for example. The property and auction listing process 224 may also be initiated by the new listing control element 102.

Once use of the listing search process is no longer desired, the user terminates the search process by simply closing the user interface 13 or the modules 94, 98, 100. However, it is understood that a logout control element (not shown) may be employed. It is understood that the control element can be any control element as desired such as a drop-down menu option, a radio button, a hyperlink, a command prompt window, and the like, or any combination thereof, for example.

As illustrated in FIG. 3, the property and auction listing process 224 permits the real estate professional to input the property and auction listing information into a select type creation module. The creation module is in communication with the management server 14 to search and analyze property and auction listing data stored in the management server 14 and save property and auction listing data to the management server 14. The property and auction listing process 224 requests the user to select a property type (e.g. residential, commercial, industrial, ranch, farmland, mining, and the like, etc.). In certain embodiments, if the property type is residential or farmland, a listing type of the property defaults to “for sale”. Further, if the property type is residential, ranch, farmland, or mining, the property and auction listing process 224 request the user to select a property subtype (i.e. single family, condo/townhouse, multi-family, residential lot, mobile home, farm with home, vacant farmland, woodland, timberland, mining quarry, and the like, etc.). Alternatively, if the property type is either commercial or industrial, the property and auction listing process 224 requests the user to select a listing type (i.e. for sale, for lease, or auction). After the listing type of the commercial or industrial property is selected, the property and auction listing process 224 requests the user to select a property subtype (i.e. retail, restaurants, office, multi-family, manufacturing, warehouse/distribution, healthcare/medical, event center/other commercial/industrial land, mobile home park, and the like, etc.).

Once the property or auction listing is created, the property and auction listing process 224 requests the user to select a location of the property or auction listing. When the user decides to select a property or auction location, the property and auction listing process 224 initiates a select property location module. The select property location module is in communication with the management server 14 to search and analyze property or auction listing data stored in the management server 14 and save property or auction listing data to the management server 14. In the select property location module, the property and auction listing process 224 requests the user to enter location information (i.e. street, city, state, zip code, and the like) of the property or auction. The property and auction listing process 224 provides a list of possible property and auction listing matches. The property and auction listing process 224 then requests the user to select a property and auction listing match. If the property or auction listing is a match, the property and auction listing process 224 requests the user to indicate whether the property or auction listing is an active listing. If the property of auction listing is an active listing, the property and auction listing process 224 provides the user with agent/broker and company information of the active listing. Further, the property and auction listing process 224 may also populate the existing active listing with any new data. Thereafter, the property and auction listing process 224 repeats the step of providing a list of possible property and auction listing matches. Alternatively, if the property or auction is not an active listing, the property and auction listing process 224 creates a new listing.

If the property or auction listing is not a match, the property and auction listing process 224 auto-populates the location information and indicates the location of the property or auction on a map. The property and auction listing process 224 then requests the user to verify a location of the property or auction. If the location of the property or auction is correct, the property and auction listing process 224 creates a new listing. Alternatively, if the location of the property or auction is incorrect, the property and auction listing process 224 requests the user to pin the correct location of the property or auction on the map. After the correct location of the property or auction is pinned on the map, the property and auction listing process 224 creates a new listing.

Once the property or auction listing is created, the property and auction listing process 224 requests the user to complete the property or auction listing by initiating a complete listing module. The complete listing module is in communication with the management server 14 to search and analyze property or auction listing data stored in the management server 14 and save property or auction listing data to the management server 14. In the complete listing module, the property and auction listing process 224 requests the user to indicate whether the property or auction listing is an auction. If the listing is not an auction listing, the property and auction listing process 224 requests the user to input additional information (i.e. photos, property type, state, city, zip, minimum price, maximum price, unit type, owner's name and contact information, mortgage information, availability time slots for showing, owner closing, scheduling and access restrictions, school district, address information, actual built-up area, age, renovation description, sewer district, furnishing description, corner unit indicator, number of bedrooms and floor location, number of bathrooms and floor location, amenities, number of stories, free form description of property, total land area, shape of land area, dimensions of rooms, income from property rental or use, high/low rise, apartment/condo facilities description, scenic views, and the like, etc.). If the listing is an auction listing, the property and auction listing process 224 requests the user to input limited additional information (i.e. photos, state, city, zip, and the like, for example). Accordingly, the property and auction listing process 224 requests the user to input various additional information based upon at type and/or subtype of the property or auction. Further, the property or auction listing is considered incomplete until the entire property and auction listing process 224 is completed. It is understood that information validations may be conducted at each step in the property and auction listing process 224. It is also contemplated the property and auction listing process 224 allows the user to attach additional documents to the property or auction listing such as disclosures and other pertinent real estate information and documents to the property or auction listing, for example.

Once the user has inputted and/or attached the additional information or documents to the property and auction listing, the property and auction listing process 224 requests the user to enter a listing date and an expiration date. It is understood that the listing date may not be prior to the current calendar date, unless the user accepts an additional fee charge. If the listing date is prior to the current calendar date, the user may be notified of and charged the additional fees. It is understood that the expiration date can be any calendar date after the current calendar date. After the listing date and the expiration date have been entered, the property and auction listing process 224 generates a property or auction listing preview, which is then reviewed by the user. If the user approves of the property or auction listing, the property or auction listing is complete. If the user disapproves of the property or auction listing, the property and auction listing process 224 repeats the steps in the complete listing module of the real estate management method until the user approves of the property or auction listing.

It is understood that the property and auction listing process 224 permits the contact and company information for the specific real estate professional to be displayed and accessible to those who view the property or auction listing. In certain embodiments, once the real estate professional creates the property or auction listing, the property or auction listing becomes immediately available to the users via the user interface 13. Typically, the property or auction listings would not be available until after 24-36 hours through the prior art MLSs. In certain embodiments, the property and auction listing process 224 may also transmit a listing creation confirmation to the user interface 13 for viewing by the real estate professional.

In certain embodiments, the property and auction listing process 224 may include a property and auction listing step (not shown) which permits the real estate professional to input listing information into a deletion module (not shown). The deletion module may be in communication with the management server 14 to delete all listing references and data associated with the property and auction listing information inputted by the real estate professional. The deletion module may also transmit a deletion confirmation to the user interface 13 for viewing by the real estate professional.

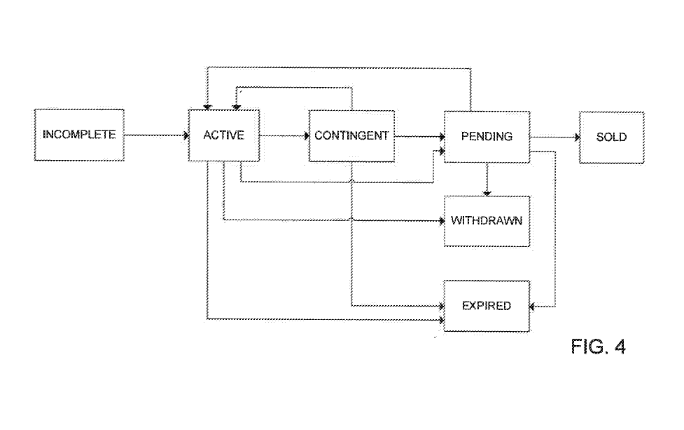

It is also contemplated that the real estate management method may further include a listing status process as illustrated in FIG. 4. Once the property and auction listing is completed, the property and auction listing is active. The active property and auction listing then become contingent when an offer is written but subject to at least one condition. Alternatively, the active property and auction listing becomes pending when an offer is presented without any conditions. As shown, the contingent property and auction listing becomes pending when the at least one condition is satisfied. Contrarily, the contingent property and auction listing becomes active when the at least one condition is not satisfied. In certain embodiments, the pending property and auction listing is ready to close (i.e. only awaiting minor legal work). The pending property and auction listing becomes sold when the property and auction listing is closed. Contrarily, the pending property and auction listing may revert to an active property and auction listing if at least one issue arises such as a legal work failure, for example. Each of the active property and auction listing, the contingent property and auction listing, and the pending property and auction listing may be withdrawn before the expiration date of the listing by an option of a seller or become expired if the expiration date of the listing is reached. It is contemplated that the user is required to extend the expiration date of the contingent and/or pending property and auction listings if not sold before the expiration date. It is also understood that at least one notification (e.g. a one day warning, a five day warning, a ten day warning, and the like, etc.) may be delivered to the real estate professional before the property and auction listings become expired.

Once use of the property and auction listing process 224 is no longer desired, the user terminates the property and auction listing process 224 via a control element (not shown). It is understood that the control element can be any control element as desired such as a drop-down menu option, a radio button, a hyperlink, a command prompt window, and the like, or any combination thereof, for example.

In certain embodiments, the client control element 104 initiates a client process of the real estate management method. The client control element 104 is in communication with the management server 14 to search and analyze client data stored in the management server 14 and save client data to the management server 14. The client control element 104 also transmits a results list 226 to the user interface 13. The user may select to view a desired client via a control element 228, edit a desired client via a control element 230, or create a new client via a control element 232. It is understood that the control elements 228, 230, 232 can be any control element as desired such as a drop-down menu option, a radio button, a hyperlink, a command prompt window, and the like, or any combination thereof, for example. If the user selects to view the desired client, a client profile 234 is transmitted to the user interface 13 for viewing, printing, emailing, and other means of use by the user. It is understood that any information electronically transmitted may be electronically transmitted via a secured and encrypted email. Alternatively, if the user selects to edit the desired client or create the new client, a client editor 236 is transmitted to the user interface 13 to permit the user to input and/or modify information pertaining to the client data. It is understood that any information electronically transmitted may be electronically transmitted via a secured and encrypted email.

Based upon the client profile 234, the user may select a client search query module 240. The client search query module 240 is in communication with the management server 14 to search and analyze client data stored in the management server 14 and save client data to the management server 14. As shown, the client search query module 240 includes an add search control element 240 and an edit search control element 242. It is understood that the control elements 240, 242 can be any control element as desired such as a drop-down menu option, a radio button, a hyperlink, a command prompt window, and the like, or any combination thereof, for example. If the user selects either the add search control element 240 or the edit search control element 242, a client search editor 244 is transmitted to the user interface 13 to permit the user to input and/or modify information pertaining to the client search data. It is understood that any information electronically transmitted may be electronically transmitted via a secured and encrypted email.

In certain embodiments, the user may also select a client profile information module 246 from the client profile 234. The client profile information module 246 is also in communication with the management server 14 to search and analyze client data stored in the management server 14 and save client data to the management server 14. As shown, the client profile information module 246 includes an edit client control element 248. It is understood that the edit client control element 248 can be any control element as desired such as a drop-down menu option, a radio button, a hyperlink, a command prompt window, and the like, or any combination thereof, for example. If the user selects the edit client control element 248, the client editor 236 is transmitted to the user interface 13 to permit the user to input and/or modify information pertaining to the client data. It is understood that any information electronically transmitted may be electronically transmitted via a secured and encrypted email.

Once use of the client process is no longer desired, the user terminates the client process by simply closing the user interface 13, the client search query module 238, or the client profile information module 246. However, it is understood that a logout control element (not shown) may be employed. It is understood that the control element can be any control element as desired such as a drop-down menu option, a radio button, a hyperlink, a command prompt window, and the like, or any combination thereof, for example.

In certain embodiments, the real estate management method includes a reporting process. When the reporting process is desired, the reporting process is initiated via the reports control element 106. It is understood that the control element 106 can be any control element as desired such as a drop-down menu option, a radio button, a hyperlink, a command prompt window, and the like, or any combination thereof, for example. It is also understood that accessibility to the reporting process can be limited to the real estate professional. The reporting process includes a reporting step in which the user inputs at least one reporting request criteria to generate at least one report. Generation of the reports is initiated via various control elements such as an agent detail report control element 250, an agent ranking report control element 252, a company detail report control element 254, a company summary report control element 256, and a company ranking report control element 258, for example. It is understood that each of the control elements 250, 252, 254, 256, 258 can be any control element as desired such as a drop-down menu option, a radio button, a hyperlink, a command prompt window, and the like, or any combination thereof, for example. Each of the control elements 250, 252, 254, 256, 258 is in communication with the management server 14 to search and analyze the property and auction listing references and data in the management server 14. The control elements 250, 252, 254, 256, 258 retrieves report information from the management server 14 based upon the at least one reporting request criteria inputted by the user.

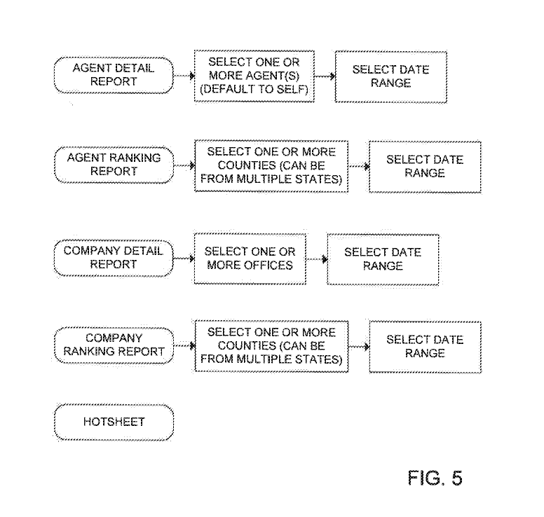

As illustrated in FIGS. 1 and 5, various reports can be generated and transmitted to the user interface 13 for viewing, printing, emailing, and other means of transmitting by the user. In certain embodiments, the reporting process generates an agent detail report 260, an agent ranking report 262, a company detail report 264, a company summary report 266, a company ranking report 268, and a hotsheet report.

When the agent detail report 260 is desired, the reporting process requests the user to select at least one agent and a desired date range. It is understood that the default agent of the agent detail report 260 is the user. When the agent ranking report 262 is desired, the reporting process requests the user to select at least one county and a desired date range. It is understood that the selected counties can be from multiple states if desired. When the company detail report 264 is desired, the reporting process requests the user to select at least one office and a desired date range. Similar to the agent ranking report 262, when the company ranking report 268 is desired, the reporting process requests the user to select at least one county and a desired date range. It is understood that the selected counties can be from multiple state if desired. When the hotsheet report is desired, the reporting process may initiate the hotsheet module 98. It is understood that other means may be employed to generate at least one of the agent detail report 260, the agent ranking report 262, the company detail report 264, the company summary report 266, the company ranking report 268, and the hotsheet report. It is further understood that any information electronically transmitted may be electronically transmitted via a secured and encrypted email.

Once use of the reporting process is no longer desired, the user terminates the reporting process via a control element (not shown). It is understood that the control element can be any control element as desired such as a drop-down menu option, a radio button, a hyperlink, a command prompt window, and the like, or any combination thereof, for example.

As illustrated in FIG. 1, the real estate management method further includes a CMA process. When the CMA process is desired, the CMA process is initiated via the CMA control element 108. The CMA process provides the user access to a various information and data to assist real estate professionals. In certain embodiments, the CMA process requests the user to select a new CMA via a control element 270 or a CMA manager via a control element 272. It is understood that the control elements 270, 272 can be any control element as desired such as a drop-down menu option, a radio button, a hyperlink, a command prompt window, and the like, or any combination thereof, for example.

If the user selects the new CMA, a CMA editor 274 is transmitted to the user interface 13 to permit the user to input and/or modify information pertaining to the CMA. It is understood that any information electronically transmitted may be electronically transmitted via a secured and encrypted email. If the user selects the CMA manager, a CMA list 276 is transmitted to the user interface 13 for viewing, printing, emailing, or other means of use by the user. Based upon the CMA list 276, the user may select to view the CMA list 276 via a control element 278 or edit the CMA list 276 via a control element 280. It is understood that each of the control elements 278, 280 can be any control element as desired such as a drop-down menu option, a radio button, a hyperlink, a command prompt window, and the like, or any combination thereof, for example. If the user selects to view the CMA list 276, the CMA list 276 is transmitted to a new tab 282 of the user interface 13 for viewing, printing, emailing, or other means of use by the user. Alternatively, if the user selects to edit the CMA list 276, the CMA editor 274 is transmitted to the user interface 13 to permit the user to input and/or modify information pertaining to the CMA. It is understood that any information electronically transmitted may be electronically transmitted via a secured and encrypted email.

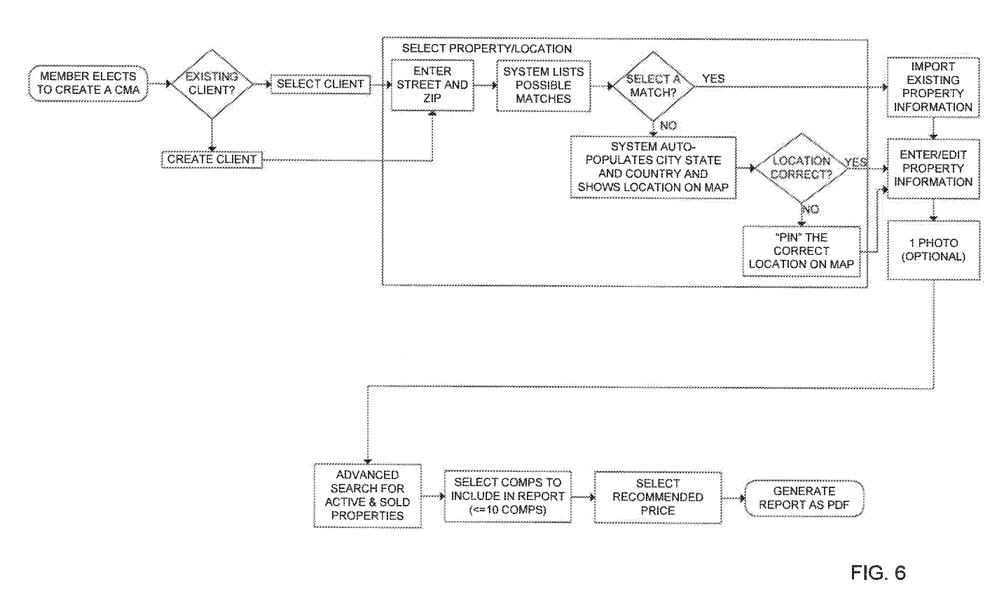

As certain embodiments shown in FIG. 6, the CMA process requests the user to create or select a desired client. When the user decides to either create or select the desired client, the CMA process initiates a select property location module. The select property location module is in communication with the management server 14 to search and analyze CMA data stored in the management server 14 and save CMA data to the management server 14. In the select property location module, the CMA process requests the user to enter location information (i.e. street, city, state, zip code, and the like) of the property. The CMA process provides a list of possible property matches. The CMA process then requests the user to select a property match. If the property is a match, the CMA process imports existing property information. Further, the CMA process may also request the user to enter and/or edit the property information as desired.

If the property is not a match, the CMA process auto-populates the location information and indicates the location of the property on a map. The CMA process then requests the user to verify a location of the property. If the location of the property is correct, the CMA process requests the user to enter and/or edit the property information as desired. Alternatively, if the location of the property is incorrect, the CMA process requests the user to pin the correct location of the property on the map. After the correct location of the property is pinned on the map, the CMA process requests the user to enter and/or edit the property information as desired.

Once the property information is entered and/or edited, the CMA process may permit the user to upload at least one photograph of the property. Thereafter, the CMA process conducts an advanced search for active and/or sold properties via at least one search criteria (e.g. date range, search radius, price, number of bedrooms, number of bathrooms, square footage, acres, lot size, number of rooms, style, foundation, exterior, school district, and the like, etc.). The CMA process then requests the user to select comparable properties (i.e. less than ten comparable properties) to include in a CMA report. Additionally, the CMA process may also request the user to select a recommended price (e.g. average price, average price adjusted for square footage, maximum price, maximum price adjusted for square footage, median price, median price adjusted for square footage, minimum price, minimum price adjusted for square footage, and the like, etc.). Once the comparable properties and the recommended price are selected by the user, the CMA process generates and transmits a CMA report to the user interface 13 for viewing, printing, emailing, or other means of use by the user. It is understood that any information electronically transmitted may be electronically transmitted via a secured and encrypted email.

Once use of the CMA process is no longer desired, the user terminates the CMA process via a control element (not shown). It is understood that the control element can be any control element as desired such as a drop-down menu option, a radio button, a hyperlink, a command prompt window, and the like, or any combination thereof, for example.

As illustrated in FIG. 1, the real estate management method further includes a resources process. When the resources process is desired, the resources process is initiated via the resources control element 110. The resources process may include at least one hyperlink on the user interface 13 to at least one real estate resource. In certain embodiments, the at least one hyperlink may connect the user interface 13 to at least one of a county auditor's website, a state real estate law website, a real estate continued education course and/or provider, a real estate association, a mortgage rate provider and/or calculator, real estate documents, a lender, an appraiser, a home inspector, an environmental inspector, and other real estate resources, for example. The user interface 13 can also be utilized to disseminate at least one of a real estate newsletter, current events, real estate new feeds and new alerts.

Once use of the resources process is no longer desired, the user terminates the resources process via a control element (not shown). It is understood that the control element can be any control element as desired such as a drop-down menu option, a radio button, a hyperlink, a command prompt window, and the like, or any combination thereof, for example.

In certain embodiments, the real estate management method may also include a third party data exchange process (not shown). The data exchange process provides a third party website host (i.e. IDX Capabilities) with controlled access to the property and auction listings inputted by the real estate professionals. However, the consumer may not be permitted to receive or view all of the information relating to the property and auction listing. For example, the consumer may not be able to receive or view information pertaining to a commission or referral fees of the real estate professionals. In certain embodiments, the data exchange process may permit the third party website host to download or automatically receive only the property and auction listings of direct clients of the third party website host.

When the data exchange process is desired, the data exchange process is initiated via a control element. It is understood that the control element can be any control element as desired such as a drop-down menu option, a radio button, a hyperlink, a command prompt window, and the like, or any combination thereof, for example. The data exchange process may include a search step in which the third party website host inputs at least one search criteria or keyword (i.e. property type, state, city, zip, minimum price, maximum price, unit type, owner's name and contact information, mortgage information, availability time slots for showing, owner closing, scheduling and access restrictions, school district, address information, actual built-up area, age, renovation description, sewer district, furnishing description, corner unit indicator, number of bedrooms and floor location, number of bathrooms and floor location, amenities, number of stories, free form description of property, total land area, shape of land area, dimensions of rooms, income from property rental or use, high/low rise, apartment/condo facilities description, scenic views, and the like, etc.) into a search query module. The search query module is in communication with the management server 14 to search and analyze property and auction listing references and data stored in the management server 14. The search query module also transmits results to the user interface 13 for viewing, printing, emailing, or other means of transmitting by the user. It is understood that any information electronically transmitted may be electronically transmitted via a secured and encrypted email.

Once use of the data exchange process is no longer desired, the third party website host terminates the data exchange process by simply closing the user interface 13. However, it is understood that a logout control element (not shown) may be employed. It is understood that the control element can be any control element as desired such as a drop-down menu option, a radio button, a hyperlink, a command prompt window, and the like, or any combination thereof, for example.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A real estate management system, comprising:
a computing device configured to at least one of collect, transmit, receive, and display nationwide real estate property and auction listing data, the computing device having a user interface accessible to at least one user; and
a management server in communication with the computing device, wherein the management server is configured to at least one of receive, analyze, and centralize the nationwide real estate property and auction listing data.

2. The real estate management system of claim 1, wherein the user is at least one of a real estate broker, a real estate agent, a real estate appraiser, a potential buyer, and a potential seller.

3. The real estate management system of claim 1, further comprising a payment server in communication with at least one of the computing device and the management server.

4. The real estate management system of claim 1, further comprising a business-to-user section in communication with at least one of the computing device and the management server, wherein the business-to-user section is configured to provide general public access to the nationwide real estate property and auction listing data.

5. The real estate management system of claim 1, further comprising a member portal in communication with at least one of the computing device and the management server, wherein the member portal is configured to provide access to the nationwide real estate property and auction listing data.

6. The real estate management system of claim 5, wherein the member portal is accessible by at least one of a login process and a registration process.

7. The real estate management system of claim 6, wherein the registration process includes at least one of a public information module, a member information module, an agent/broker verification module, a company creation module, a payment module, a company selection module, and an approval module.

8. The real estate management system of claim 5, wherein the member portal includes a member section configured to provide the user with access to various information and data to assist real estate professionals.

9. The real estate management system of claim 8, wherein the member section includes at least one of a member process, an agent/broker search process, a company search process, a listing search process, a property and auction listing process, a listing status process, a client process, a reporting process, a comparative market analysis process, a resources process, and a third party data exchange process.

10. The real estate management system of claim 9, wherein the property and auction listing process includes at least one of a select type creation module, a select property location module, and a complete listing module.

11. The real estate management system of claim 9, wherein the comparative market analysis process includes a select property location module.

12. A real estate management method, comprising the steps of:
providing a computing device configured to at least one of collect, transmit, receive, and display nationwide real estate property and auction listing data, the computing device having a user interface accessible to at least one user;
providing a management server in communication with the computing device, wherein the management server is configured to at least one of receive, analyze, and centralize the nationwide real estate property and auction listing data; and
centralizing the nationwide real estate property and auction listing data.

13. The real estate management method of claim 12, further providing a business-to-user section in communication with at least one of the computing device and the management server, wherein the business-to-user section is configured to provide general public access to the nationwide real estate property and auction listing data.

14. The real estate management method of claim 12, further providing a member portal in communication with at least one of the computing device and the management server, wherein the member portal is configured to provide access to the nationwide real estate property and auction listing data.

15. The real estate management method of claim 14, wherein the member portal is accessible by at least one of a login process and a registration process.

16. The real estate management method of claim 15, wherein the registration process includes at least one of a public information module, a member information module, an agent/broker verification module, a company creation module, a payment module, a company selection module, and an approval module.

17. The real estate management method of claim 14, wherein the member portal includes a member section configured to provide the user with access to various information and data to assist real estate professionals.

18. The real estate management method of claim 17, wherein the member section includes at least one of a member process, an agent/broker search process, a company search process, a listing search process, a property and auction listing process, a listing status process, a client process, a reporting process, a comparative market analysis process, a resources process, and a third party data exchange process.

19. The real estate management method of claim 18, wherein the property and auction listing process includes at least one of a select type creation module, a select property location module, and a complete listing module.

20. A real estate management method, comprising the steps of:
providing a computing device configured to at least one of collect, transmit, receive, and display nationwide real estate property and auction listing data, the computing device having a user interface accessible to at least one user;
providing a management server in communication with the computing device, wherein the management server is configured to at least one of receive, analyze, and centralize the nationwide real estate property and auction listing data;
centralizing the nationwide real estate property and auction listing data;
providing a business-to-user section in communication with at least one of the computing device and the management server, wherein the business-to-user section is configured to provide general public access to the centralized nationwide real estate property and auction listing data; and
providing a member portal in communication with at least one of the computing device and the management server, wherein the member portal is configured to provide real estate professionals access to the centralized nationwide real estate property and auction listing data.
